(19) United States
(12) Patent Application Publication
(10) Pub. No.: US 2008/0009295 A1
(43) Pub. Date: Jan. 10, 2008

(54) Method for the high accuracy geolocation of outdoor mobile emitters of CDMA cellular systems

(76) Inventors: Nicole Brousseau, Ottawa (CA); Geoffrey Colman, Ottawa (CA); James S. Wight, Ottawa (CA)

Correspondence Address: STITES & HARBISON PLLC, 1199 NORTH FAIRFAX STREET, SUITE 900, ALEXANDRIA, VA, 22314, US

(21) Appl. No.: 11/482,102

(22) Filed: Jul. 7, 2006

(51) Int. Cl. H04Q 7/20

(52) U.S. Cl. 455/456.1

(57) ABSTRACT

A high-accuracy method for the geolocation, without the collaboration of the network, of outdoor mobile emitters of a CDMA cellular system, based on the ability to distinguishing between line-of-sight and reflected signals. The method employs time-of-flight and angle-of-arrival information in order to determine whether a signal received by each of two or more interceptors situated at different locations is line-of-sight or reflected. Time-of-flight information is obtained with the aid of the reverse link of a mobile of interest. At those instances in time when the signal received at two or more interceptors is line-of-sight, the location of the mobile can be accurately determined using conventional direction-finding techniques. Since the signal received by an interceptor from a mobile may be very weak, adaptive threshold digital signal processing techniques may be employed to control the probability of detection and the probability of false alarms.

### FIELD OF THE INVENTION

The present invention relates generally to a high-accuracy method for the geolocation, without a collaboration of a network, of outdoor mobile emitters of CDMA cellular systems, based on an ability to distinguish between line-of-sight and reflected signals.

### BACKGROUND OF THE INVENTION

In all forms of geolocation there currently exist no techniques to determine if a first-to-arrive signal reaching an interceptor employed in the geolocation of a mobile of a CDMA cellular system is a line-of-sight signal or a reflected signal. Although some mitigation of the presence of reflected signals is possible by using techniques such as spatial filtering or other sophisticated signal processing techniques, no technique exists at present to determine if the first-to-arrive signal is a line-of-sight signal or a reflected signal. This causes a substantial deterioration of any geolocation results, as it is impossible to determine if the location is calculated from valid, line-of-sight signals or from erroneous data originating from reflected signals.

For example, in ‘CDMA Infrastructure-Based Location Finding for E911’, J. O'Connor, B. Alexander and E. Schorman, 1999 IEEE 49^{th} Vehicular Technology Conference, vol. 3., p. 1973-1978, a geolocation method is proposed where the collaboration of the mobile and of the infrastructure is assumed. In that technique, no attempt is made to distinguish if the signal being processed is a line-of-sight signal or a reflected signal. Similarly, in ‘Performance Analysis of ESPRIT, TLS-ESPRIT and UNITARY-ESPRIT Algorithms for DOA Estimation in a W-CDMA Mobile System, K. AlMidfa, G. V. Tsoulos and A. Nix, First International Conference on 3G Mobile Communication Technologies, Conference Publication No. 471, 2000, p. 2000-2003, various signal processing techniques are evaluated. However, no attempt is made to distinguish if the signals being processed are line-of-sight signals or reflected signals.

### SUMMARY OF THE INVENTION

It is an object of the present invention to provide a high-accuracy method for the geolocation, without a collaboration of a network, of outdoor mobile emitters of a CDMA cellular system, based on the ability to distinguishing between line-of-sight and reflected signals. According to one aspect of the invention, it provides a method for the outdoor geolocation of a mobile of interest in a CDMA cellular system comprising steps of: (i) dynamically and wirelessly receiving a signal from a mobile whose location is unknown at two or more interceptors, which are located at different known geographic locations inside a CDMA coverage area defined by said base station where a signal from said base station to said mobile is line-of-sight; (ii) dynamically computing a total time-of-flight of said signal from said base station to each interceptor via said mobile; (iii) dynamically computing an ellipse of position of said mobile for each total time-of-flight computation, where each ellipse of position has as its foci said base station and said interceptor corresponding to said total time-of-flight measurement for said interceptor; (iv) dynamically computing intersection point(s) of each possible pair of ellipses of position, if any such intersection point exists; (v) dynamically and wirelessly receiving said signal from said mobile and measuring an angle-of-arrival of said signal received at each of said interceptors; (vi) dynamically computing a line of position corresponding to each angle-of-arrival measurements; (vii) dynamically computing an intersection point of each possible pair of line of position based on angle-of-arrival measurements, if such an intersection point exists; (viii) dynamically comparing said intersection point(s) of each pair of ellipses of position, if any such intersection point exists with the corresponding intersection point of said lines of position based on angle-of-arrival measurements, if such an intersection point exists; and (ix) determining either (a) a geographic area within which the mobile is located that is defined by the area of intersection of all ellipses of position whenever for all possible pair of interceptors, either no intersection point of the angle-of-arrival lines of position corresponding to a pair of interceptors coincides with the intersection point(s) of the ellipses of position corresponding to the same pair of interceptors, or no intersection point of angle-of-arrival lines of position exists, or (b) the actual position of the mobile whenever the signal from the mobile to each of any pair of interceptors is line-of-sight which occurs whenever the intersection point of the angle-of-arrival lines of position corresponding to the interceptors intersects one of the two intersection points of the ellipses of position corresponding to the interceptors, corresponding to the actual position of the mobile at that time.

According to another aspect of the invention, it provides a system for the outdoor geolocation of a mobile of interest in a CDMA cellular system comprising of a plurality of interceptors located at known location inside a CDMA coverage area of a base station, wherein each of said interceptors comprising of: (i) a means for obtaining a total-time-of-flight measurement, which is a total propagation time of a signal from said base station to said mobile and from said mobile to said interceptor; (ii) a means for obtaining an angle-of-arrival measurement of a signal from said mobile; (iii) a means for distinguishing whether said signal received from said mobile is line-of-sight or reflected; and (iv) a means for determining a location of said mobile.

### BRIEF DESCRIPTION OF THE DRAWINGS

The invention will now be described in more detail with reference to the accompanying drawings, in which:

FIG. 1 illustrates how, according to the method as recited in the present invention, time-of-flight and angle-of-arrival information of a line-of-sight signal to a single interceptor can be used to locate a mobile in a CDMA cellular coverage area;

FIG. 2 illustrates how two interceptors can be used to determine the possible positions of a mobile in a CDMA cellular coverage area where the signal propagation is line-of-sight;

FIG. 3 illustrates how the use of two interceptors in a CDMA coverage area can provide information concerning the boundaries within which a mobile is located when a reflection in the signal propagation path between the mobile and one of the interceptors is present;

FIG. 4 illustrates that if the signal path from a base station defining a CDMA coverage area to a mobile is line-of-sight and the non-line-of-sight signal path from the mobile to an interceptor contains only one point of reflection, the point of reflection will lie along the angle-of-arrival line of position;

FIG. 5 illustrates that the ellipses of position corresponding to the range of all possible points of reflection along an angle-of-arrival line of position will be smaller than the corresponding principal ellipse having its foci at the base station defining a CDMA coverage area and an interceptor located in that area;

FIG. 6 illustrates how the use of two interceptors in a CDMA coverage area can provide information concerning the boundaries within which a mobile is located when a reflection in the signal propagation path between the mobile and each of the interceptors is present;

FIG. 7 illustrates that when the intersection point of two angle-of-arrival lines of position does not intersect either of the two intersection points of two principal ellipses associated with two interceptors located at different points, the signal received at one or more of the two interceptors from a mobile within a CDMA coverage area defined by a base station is reflected;

FIG. 8 illustrates that when the intersection point of two angle-of-arrival lines of position intersects either of the two intersection points of two corresponding principal ellipses associated with two interceptors located at different points, the signal received at both interceptors from a mobile within a CDMA coverage area defined by a base station is line-of-sight;

FIG. 9 illustrates the use of a four-antenna Watson-Watt array to compute a coarse angle-of-arrival of a signal at one of the antennas;

FIG. 10 illustrates the use of a three-antenna Watson-Watt array to compute a coarse angle-of-arrival of a signal at one of the antennas;

FIG. 11 illustrates a high gain adaptive threshold determination signal processing method applied to a weak signal received from a mobile within a CDMA system; and

FIG. 12 illustrates the relationship between frame rates and power control groups in an IS-95 CDMA cellular system.

### DETAILED DESCRIPTION OF THE INVENTION

In all forms of geolocation applied to CDMA cellular systems there currently exist no techniques to determine if the first-to-arrive signal reaching an interceptor employed in the geolocation of a mobile is a line-of-sight signal or a reflected signal. This causes a substantial deterioration of the geolocation results, as it is impossible to determine if the location of the mobile is calculated from valid, line-of-sight signals or from erroneous data originating from reflected signals.

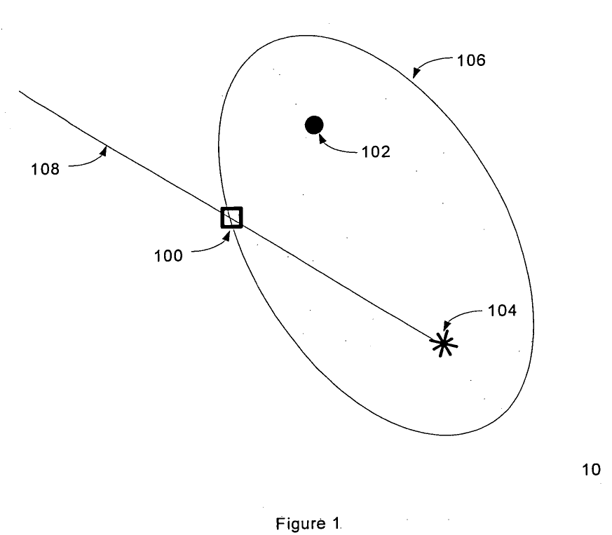

According to a method described herein and illustrated in FIG. 1, time-of-flight and angle-of-arrival information of a line-of-sight signal can be used to locate a mobile 100. A base station 102 defining a CDMA coverage area 10 dynamically receives network timing through the synchronization procedure associated with the CDMA cellular system (not shown). The base station 102 then distinguishes itself by transmitting a short code having a particular offset with respect to the network timing of the CDMA cellular system. Upon receiving a base station signal, the mobile 100 will be informed of the base station 102 short code offset. The mobile 100 then transmits its own short code with zero time-offset with respect to the network timing. Of course, this short code will be delayed with respect to the network timing by the time it took for the base station 102 signal to propagate to the mobile 100. An interceptor 104 capable of receiving a signal from the mobile knows its own physical location, as well as that of the base station 102. It will also have access to the network timing through the synchronization procedure associated with the CDMA cellular system (not shown) and accounting for any timing delays resulting from the separation between the interceptor 104 itself and the base station 102. The first approach is preferable since the second assumes line-of-sight signal propagation between the base station and the interceptor. By knowing the network timing, and by receiving the short code from the mobile 100, the interceptor 104 can determine the total time-of-flight of a signal both from the base station 102 to the mobile 100 and from the mobile 100 to the interceptor 104. If a single interceptor 104 is employed, a mobile 100 will be located on an ellipse of position 106 having the base station 102 and the interceptor 104 located at the foci, assuming line-of-sight signal propagation between the mobile 100 and the interceptor 104. Angle-of-arrival information of the signal at the interceptor 104 can also be determined using Watson-Watt antenna arrays and monopulse measurements at the interceptor location, as further described below. The location of the mobile 100 can be determined as the intersection of the ellipse of position 106 and angle-of-arrival line of position 108 passing through the mobile 100 and the interceptor 104.

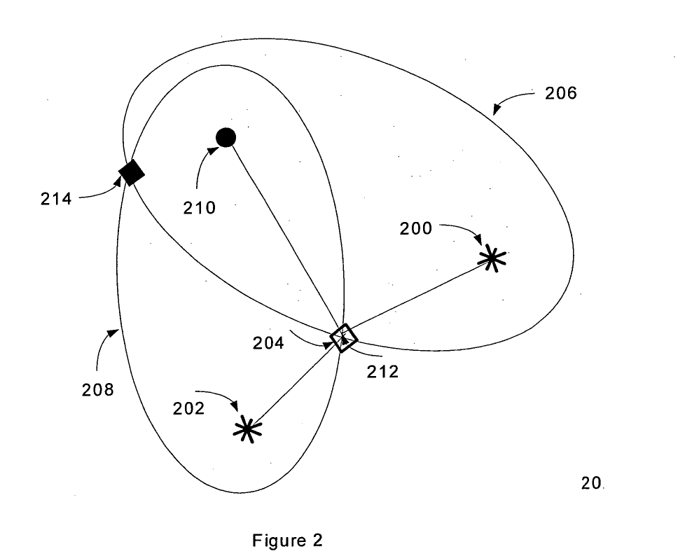

FIG. 2 illustrates how two interceptors 200 and 202 can be used to determine the possible positions of a mobile 204 in a CDMA cellular coverage area 20 where the signal propagation is line-of-sight. In such a case, two ellipses of position 206 and 208 are obtained both having the base station 210 defining the cellular coverage area 20 at a common focal point, and interceptor 200 or 202 situated at the remaining focal point of each ellipse, respectively. The two ellipses 206 and 208 will always intersect each other at two and only two locations 212 and 214. Again assuming line-of-sight signal propagation, the mobile 204 will be located only at one of these two intersection points 212 or 214.

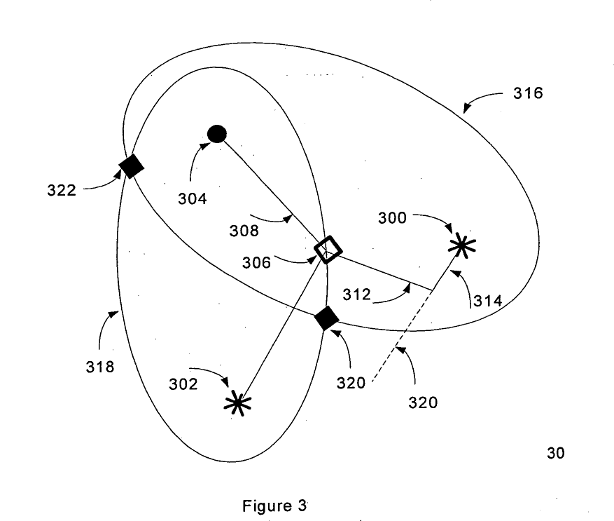

FIG. 3 illustrates how the use of two interceptors 300 and 302 located at different points and capable of receiving a signal from a mobile 306 situated in a CDMA coverage area 30 defined by a base station 304 can provide information concerning the boundaries within which the mobile 306 is located when a reflection in the signal propagation path between the mobile 306 and one of the interceptors 300 is present. It is noteworthy that in such situations, a link between the base station 304 and mobile 306 is assumed to be line-of-sight 308, since the base station 304 is probably located in a highly visible location. However, the link between the mobile 306 and an interceptor 300 may be non line-of-sight, resulting in a reflection in the signal, which follows a “dog leg” path 312 and 314 from the mobile 306 to the interceptor 300. In such a situation, the corresponding elliptical line of position 316, and the angle-of arrival line of position 320 do not yield direct information on the location of the mobile 306. However they do provide information on the boundaries of the area in which the mobile 306 is located. In the situation where there is line-of sight propagation between the mobile 306 and the interceptor 302 (in addition to line-of-sight propagation from the base station 304 to the mobile 306), the mobile 306 will be located somewhere on the ellipse of position 318 having the base station 304 and interceptor 302 at the foci. An ellipse, such as 318, that has the base station 304 and an interceptor 302 as its foci, and that encompasses all possible locations of the mobile 306 is called a principal ellipse. A principal ellipse, such as 318 or 316 is defined through the measurement of the total time-of-flight of a signal between the base station 304 and the interceptor 300 or 302, respectively via the mobile 306. The mobile 306 will be located along the portion of the principal ellipse 318 situated inside the principal ellipse 316. This assumes that the reflection is not located very far from an interceptor 300 or 302, which is most likely to be the usual situation. However, in an extreme case, the reflection may be very far from an interceptor, making the ellipse 316 computed from the corresponding time-of-flight measurement so large that ellipse 318 lies completely within ellipse 316. In that case, intersection points 324 and 322 will not exist. This extreme scenario is not shown in the Figures.

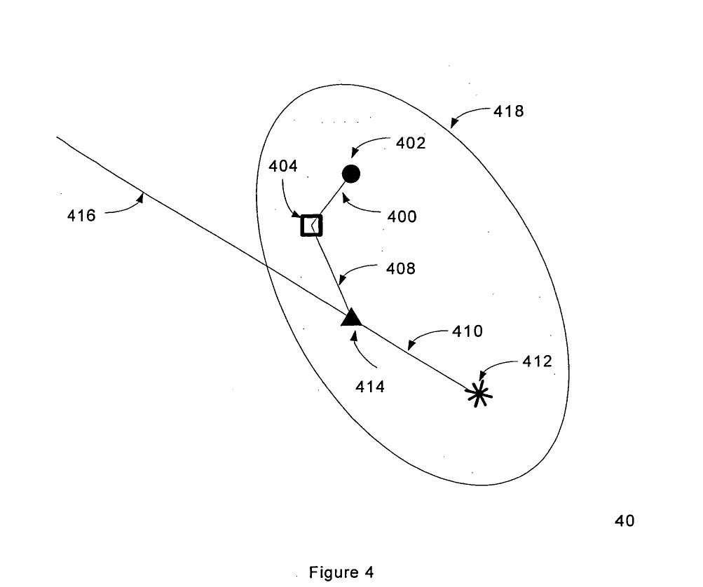

FIG. 4 illustrates that if the signal path 400 from a base station 402 defining a CDMA coverage area 40 to a mobile 404 is line-of-sight and a reflected signal path 408 and 410 from the mobile 404 to an interceptor 412 contains only one point of reflection 414, that point of reflection 414 will lie along the angle-of-arrival line of position 416. As before, the total time-of-flight of the signal from the base station 402 to the interceptor 412 via the mobile 404 defines a principal ellipse 418.

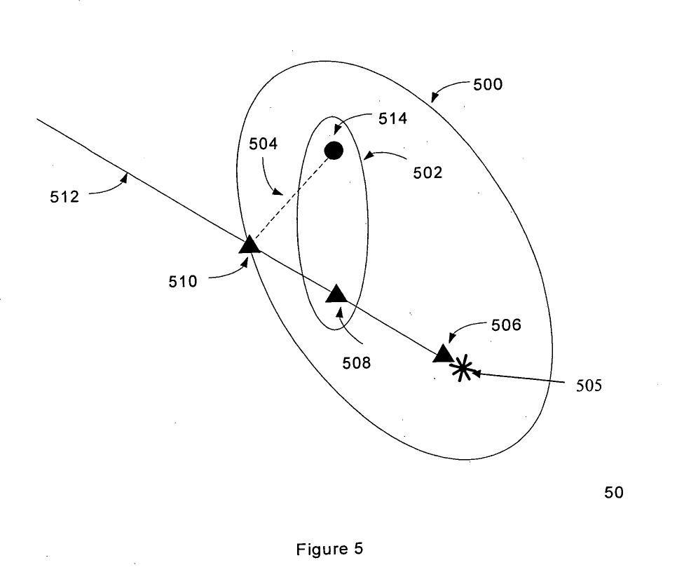

FIG. 5 illustrates that the ellipses of position 500, 502 and 504 (which is a degenerate ellipse) corresponding to the range of all possible points of reflection including 506, 508 and 510 along an angle-of-arrival line of position 512 will be equal to or smaller than the corresponding principal ellipse 500 having its foci at the base station 514 defining a CDMA coverage area 50 and at an interceptor 505 located in that area 50. For each possible point of reflection, such as 506, 508 and 510 along an angle-of-arrival line of position 512, the time-of-flight from the base station 514 to the assumed point of reflection 506, 508 or 510 via a mobile (not shown) can be calculated. For each assumed point of reflection, such as 506, 508 and 510, an elliptical line of position 500, 502 and 504 can be established having the base station 514 and the assumed point of reflection 506, 508 or 510 as the foci. As the assumed point of reflection moves away from the interceptor 506 (along the angle-of-arrival line of position 512) to the edge of the principal ellipse 510, the corresponding ellipses of position (from 500 to 504) all remain within the principal ellipse 500 and become more elliptical until the ellipsis of position degenerates into a straight line 504 connecting the foci 514 and 510 when the point of reflection 510 intersects the principal ellipse 500. A point of reflection cannot exist beyond the intersection 510 of the angle-of-arrival line of position 512 and the principal ellipse 500.

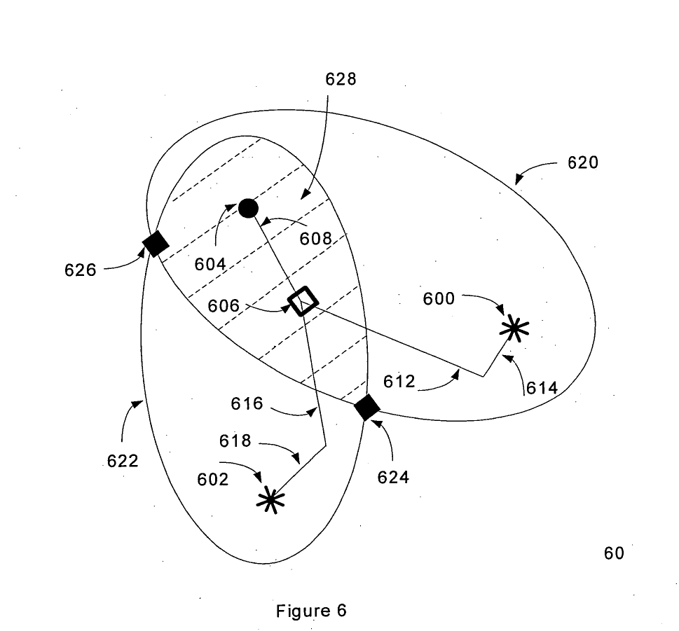

FIG. 6 illustrates how the use of two interceptors 600 and 602 situated at different points and capable of receiving a signal from a mobile located in a CDMA coverage area 60 defined by a base station 604 can provide information concerning the boundaries within which a mobile 606 is located when a reflection in the signal propagation path between the mobile 606 and each of the two interceptors 600 and 602 is present. Once again, the link from the base station 604 to mobile 606 is assumed to be line-of-sight 608, since the base station 604 is probably located in a highly visible location. However, the link between the mobile 606 and each of interceptors 600 and 602 may be non line-of-sight, resulting in a reflection in the signal, which follows a “dog leg” path 612 and 614 from the mobile 606 to the interceptor 600, and a “dog leg” path 616 and 618 from the mobile 606 to the interceptor 602. The two principal ellipses generated from the measured total time-of-flight between the base station 604 and the intercept sites 600 and 602 via the mobile 606 will intersect each other at only two points 624 and 626, and the mobile 606 will lie somewhere in the intersection area 628 of the two principal ellipses 620 and 622.

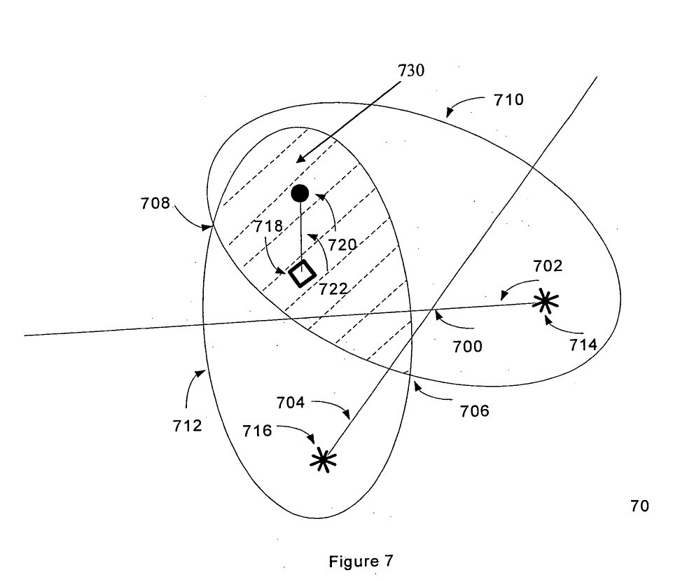

FIG. 7 illustrates that when the intersection point 700 of two angle-of-arrival lines of position 702 and 704 does not coincide with either of the two intersection points 706 or 708 of two corresponding principal ellipses 710 and 712 determined from the total time-of-flight of signals received at one or more of two interceptors 714 and 716, respectively, via a mobile 718 from a base station 720 defining a CDMA coverage area 70, the signal from the mobile 718 to one or both of the interceptors 714 and 716 is reflected, assuming that the signal from the base station 720 to the mobile 718 is line of sight 722. It is also possible for the angle-of-arrival lines of position 702 and 704 not to intersect each other (not shown). When this occurs, it is also an indication that there is a reflection between the mobile 718 and one or both of the interceptors 714 and 716. Since the intersection point 700 of the lines of positions based on angle-of-arrival measurements does not coincide with the intersection points of two corresponding principal ellipses 710 and 720, the mobile of interest is deemed to be located inside an intersection area 730 of two corresponding principal ellipses 710 and 720. It is also possible that no intersection of a corresponding pair of lines of position of angle-of-arrival measurements may be found. In such case, as well, a mobile of interest is deemed to be located within an area of intersection areas of a corresponding pair of principal ellipses of position.

Although the discussions of FIGS. 3 to 7 only illustrated single reflections in the path between a mobile of interest and an interceptor, the principles described with reference to those Figures also apply if there are multiple reflections in such a path.

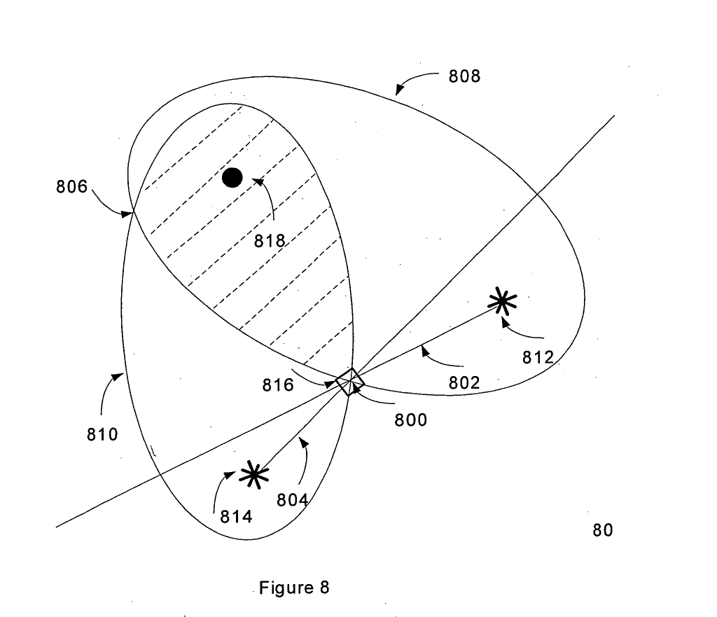

FIG. 8 illustrates that when the intersection point 800 of two angle-of-arrival lines of position 802 and 804 intersects either of the two intersection points 800 or 806 of two corresponding principal ellipses 808 and 810 determined from the total time-of-flight of signals received at one or more of two interceptors 812 and 814, respectively, via a mobile 816 from a base station 818 defining a CDMA coverage area 80, the signal from the mobile 816 to both of the interceptors 812 and 814 is line-of-sight. This situation not only confirms that line-of-sight propagation has taken place, it also will identify which of the intersection points 800 or 806 of the principal ellipses is the actual location of the mobile.

The techniques described above can be used to determine if signals received from a mobile are line-of-sight as in FIG. 8 or reflected signals as in FIG. 7. If the signals are line-of-sight, the actual location of the mobile can also be determined. The technique can be applied to mobiles that are moving. In such cases, the angle-of-arrival lines of position and the principal ellipses will be dynamically changing. As the mobile moves it may enter a location for which both of the paths from the mobile to an interceptor becomes line-of-sight. At this instant, the intersection point of the angle-of-arrival lines of position will cross one of the current intersection points of the principal ellipses, and establish the location of the mobile.

Although the preceding discussion has only described the use of two interceptors, in practice more interceptors will usually be used, and the methods described above will be applied to the each possible pair of interceptors, in turn. The greater the number of interceptors used, the greater will be the probability that the signal from the mobile of interest to each of at least one possible pair of interceptors will be line-of-sight thereby yielding the actual location of the mobile. Even if that is not the case, by comparing the intersection areas of each possible pair of ellipses of positions generated for the interceptors employed to locate the mobile of interest at a point in time, it is possible to define the possible area within which the mobile is located at that point in time as the intersection area of all of the possible pair of ellipses of position generated for the number of interceptors employed. This defined area will typically decrease as the number of interceptors is increased.

In sum, this mobile geolocation method depends on the ability to monitor total time-of-flight and angle-of-arrival information of a desired signal. It is possible to continuously monitor the time-of-flight of a mobile's forward link signal through acquisition of the mobile's reverse link channel, as described below. It is also possible to instantaneously determine the angle-of-arrival at interceptor sites using well-known direction-finding techniques, also described below.

In order to obtain the total time-of-flight as well as the angle-of-arrival information required to apply the techniques discussed above, the reverse link access channel or traffic channel must be acquired. To achieve this, each interceptor must first acquire the base station pilot channel consisting of one or more short codes with a network timing-offset associated with the base station or its particular sector.

This general technique applicable to any CDMA cellular system can be illustrated in the following description of a preferred embodiment for computing total time-of-flight in an IS-95 CDMA cellular system. In such a case, the short codes employed would be the I and Q short codes.

With time synchronization of the pilot channel, the interceptor can also easily obtain the forward link sync channel. In the IS-95 CDMA cellular system, this consists of time-offset I and Q short codes with a Walsh 31 code overlay (at the same chip rate) carrying convolutionally encoded and interleaved data at a base rate of 1.2 kbps. The information on the sync channel consists of the network timing, and position of the long code at the start of 4^{th} 80 milliseconds super frame following the super frame in which the information is being transmitted. The network timing determines the short code offset used by the base station.

With the long code position known, the interceptor can receive the forward link paging channels. These channels consist of time-offset I and Q short codes, with known Walsh code overlays and (decimated) long code scrambling. The channels carry channel assignment data and other system overhead information. This channel assignment data can be used to build the mobile's mask for generating its unique offset of the long code.

With the mobile's mask and network timing, the interceptor can receive the access channel and the traffic channel from the mobile in the reverse link band.

The reverse link traffic channel from the mobile provides the interceptor with a continuous stream of concatenated Walsh codes modulated with zero time-offset (but symbol offset) I and Q short code and long code spreading using the mobile's unique mask. With knowledge of the mobile's long code mask, the time-of-arrival of the first signal to arrive at the interceptor can be determined.

From knowledge of the network timing obtained from GPS and of the offset used by the base station in the transmission of the I or Q short code, the time of transmission at the base station can be determined. By taking the difference of this time and the time-of-arrival of the start of the I or Q short code, the total time-of-flight from the base station to the mobile to the interceptor can be determined.

The angle-of-arrival measurements are performed in two stages; a fast (instantaneous) coarse measurement followed by an accurate, monopulse measurement, whose accuracy can be improved even further through the application of digital signal processing techniques, all as more specifically described below.

Coarse angle-of-arrival measurements can be made with the use of one of three well known techniques: antenna main beam or null pointing direction, Doppler measurement from a revolving antenna or from a ring of commutating antennas, and phase measurement between separate receiving antennas. Of these, the first two approaches require a large physical antenna, or ring around which an antenna is revolved or around which many antennas are commutated. The phase measurement technique provides the angle-of-arrival measurement of comparable accuracy with a much smaller physical size. Further it does not require rotating mechanisms. In addition, measurements performed using this technique, are instantaneous.

In a preferred embodiment, the coarse angle-of-arrival measurement is accomplished using a well-known technique based on measuring the relative phase of a received signal between two or more separate antennas, called the Watson-Watt array. For azimuth determination (in the presence of an accompanying elevation component), either an array of 3 or 4 antennas can be used.

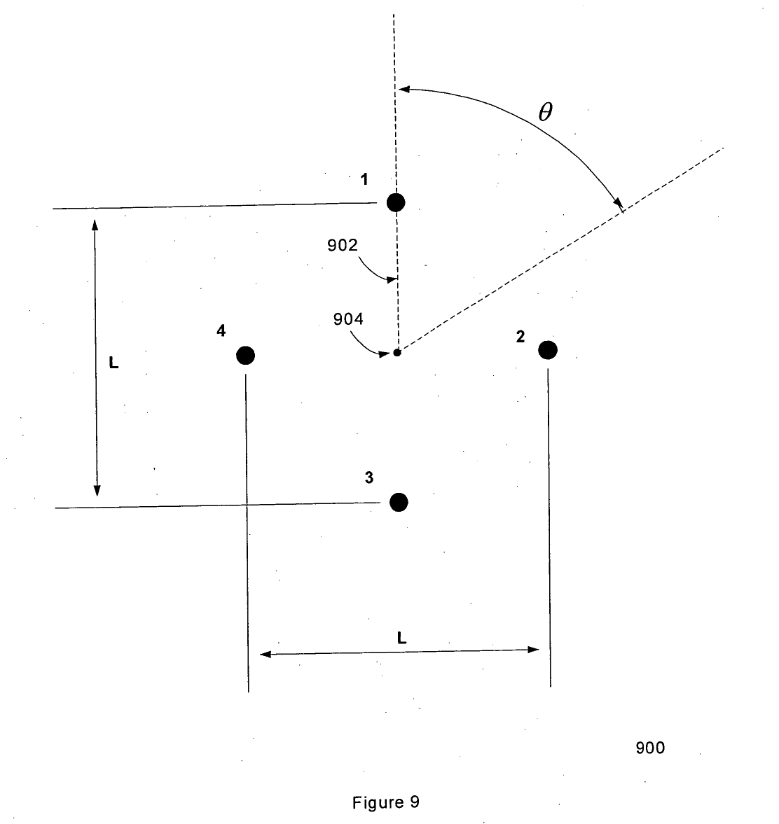

FIG. 9 shows the use of a four-antenna array 900. In such an array, the distance L between antennas 1 and 3 is the same as the distance between antennas 2 and 4. The angle-of-arrival θ of a signal is the angle at which a signal arrives relative to a straight imaginary line 902 passing through antennas 1 and the centre of the antenna array 904. The angle-of-arrival θ can be determined indirectly using the phase differences (not shown) measured between each of two pair of antennas using the following equations:

θ=atan(φ₂₄/φ₁₃)

or

θ=atan(φ₂₃/φ₁₂)−45

where φᵢⱼ is the phase difference of a signal between antennas i and j

It should be noted that antenna pairs 1-4 and 4-3 give the same equation as antenna pairs 2-3 and 1-2. This provides a third redundant measurement.

It is interesting to observe that since their spacing is 0.707 L, the sensitivity of pairs 1-2, 2-3, 3-4, and 4-1 is reduced by a factor of 0.707 compared to that of pairs 1-3 and 2-4, and the standard deviation of their errors is increased by 1.414. However this is compensated for by the fact that they form redundant pairs.

In order to minimize interceptor's receiver complexity, an angle-of-arrival determination based on the 4-antenna array could use just the phase difference measurements between antennas 2 and 4, and between antennas 1 and 3.

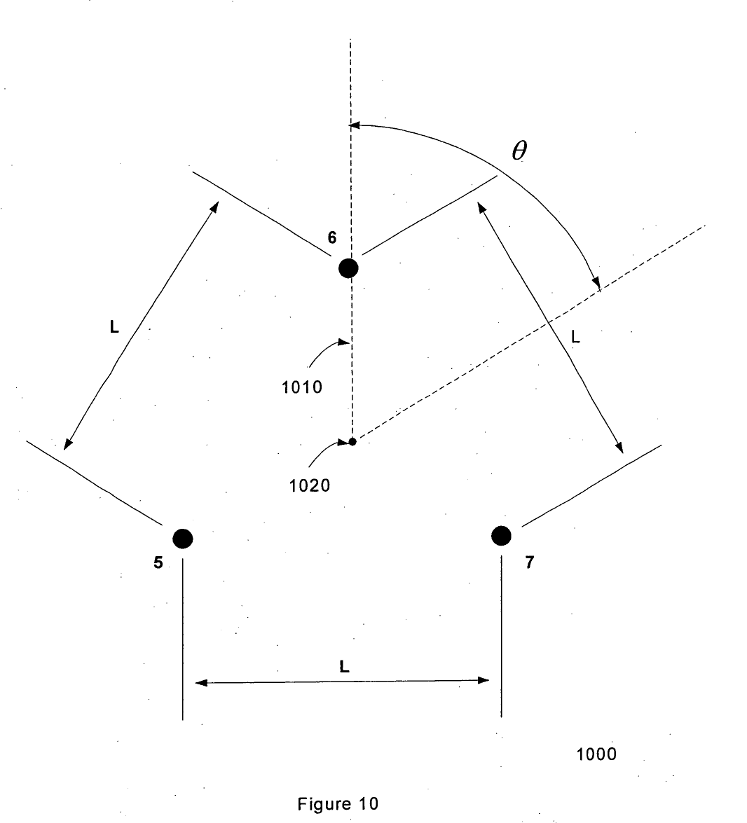

FIG. 10 shows the use of a three-antenna array 1000. In such an array, the distance L between each pair of antennas 5-6, 6-7 and 7-5 is the same. The angle-of-arrival θ is the angle at which a signal arrives relative to a straight imaginary line 1010 passing through antenna 6 and the center of the antenna array 1020. The angle-of-arrival θ of a signal relative to an antenna 6 can be determined indirectly using the phase differences (not shown) measured between the various possible pair of antennas using the following equation:

θ=atan{1.732 φ₅₇/φ₇₆−φ₆₅)}

More accurate angle-of-arrival measurements can be made using well-known monopulse techniques when the mobile is line-of-sight and its coarse location is known. In theory, monopulse can be either amplitude or phase comparison in nature. In practice, amplitude comparison monopulse provides better performance than phase comparison, being less sensitive to mechanical tolerances. Accuracy of 0.01 degree is achievable, particularly when digital signal processing techniques designed to increase signal to noise ratio are applied, as described below, to the signal received from the mobile to be located when the monopulse technique is applied to the signal.

Another problem that must be overcome by the present invention, is ensuring that the signal received at the interceptor, which can be quite weak, can actually be distinguished from any associated noise so that the time-of-flight and angle-of arrival data yielded by the techniques described above will be reliable. The following discussion describes the manifestation of the problem in the context of an IS-95 CDMA cellular system. However, the problem may arise in any CDMA cellular system and the technique employed to overcome the problem described below can be applied in general to any CDMA system.

In an IS-95 CDMA system operating at full rate, the reverse link of the system has a signal processing gain of 21 dB. After demodulation, the signal to noise ratio of the data demodulated by a base station is expected to be of the order of 6 to 7 dB. This means that the signal to noise ratio of the signal reaching the base station is of the order of −15 dB. It is to be noted that the base station controls the power emitted by the mobiles in such a way that the base station receives the same power from all the mobiles. This is to minimize the mutual interference of the mobiles and to achieve the maximum capacity of the cell. Consequently, the power transmitted by a mobile located close to the base station is likely to be much smaller than the power transmitted by a mobile located far from the base station.

A receiver, such as an interceptor, trying to intercept the signal from a mobile located close to the base station is likely to have very little power to work on. In such a case high-gain signal processing will be required to handle the situation. Receiving a signal from a mobile located far from the base station should be less problematic as the mobile is likely to emit more power. Consequently, in order to be able to operate on a good selection of mobile positions, an interceptor should be able to provide a large gain as it is likely to have to process signals with a much smaller signal to noise ratio that the −15 dB expected at the base station.

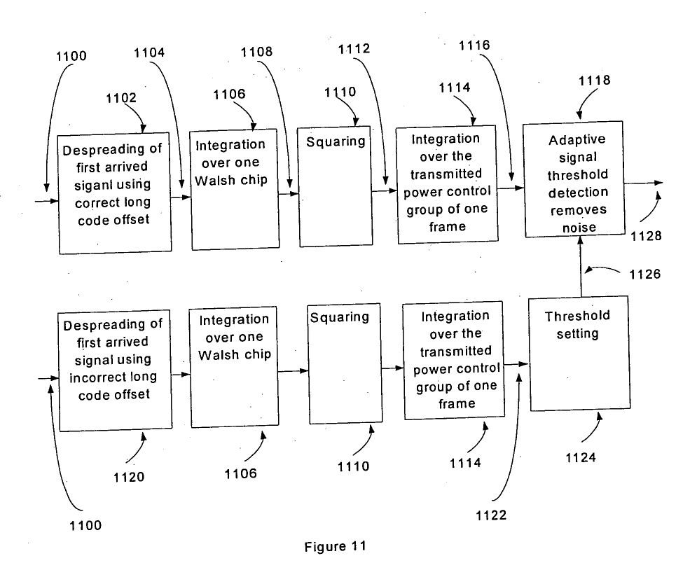

FIG. 11 illustrates an adaptive high-gain signal processing method applied to a signal 1100 received from a mobile (not shown) at the interceptor. The first step 1102 is the despreading (i.e., stripping of the long code and the short codes) of the signal 1100 using a stored reference signal (not shown) having the long code offset mask used by the mobile of interest and the time-of-arrival of the first-to-arrive signal of the mobile of interest. The despreading 1102 produces an output signal 1104 consisting of concatenated Walsh codes with Walsh chips that have a duration of four spreading chips. The next operation 1106 consists of integrating the four spreading chips included in each Walsh chip. The knowledge of the network timing previously acquired during the synchronization permits to determine the location of the boundaries of the Walsh chips. After this operation, the signal 1108 consists of Walsh chips that are either positive or negative. Up to this point, the signal processing is identical to what the receiver of a base station normally performs. The following steps are novel and essential to the proper functioning of the direction finding operation.

The next step 1110 is the squaring of the Walsh chips. The resulting output signal 1112 will have a signal to noise ratio that is twice the signal to noise ratio of the input signal 1108 processed in this manner. Thus, for example, a signal to noise ratio of −20 dB before squaring would be −40 dB after squaring. The next step 1114 is the integration over the transmitted power control groups of one frame. This integration produces the gain that is required to overcome the very negative signal to noise ratio and produce a high gain detectable signal 1116.

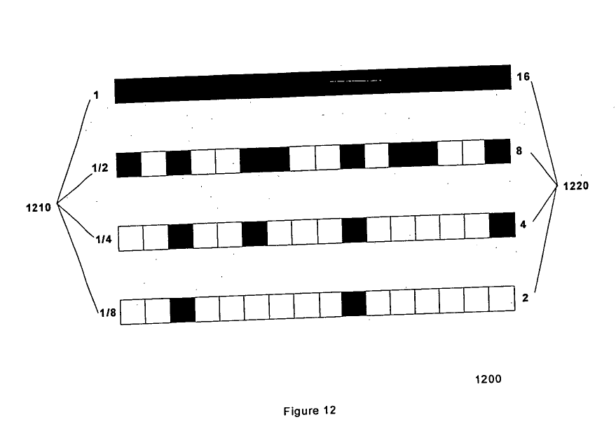

As illustrated in FIG. 12, in an IS-95 cellular system a frame 1200 contains 16 power control groups 1210 and when the system is operating at rate 1220 1, ½, ¼ or ⅛, either 16, 8, 4 or 2 power control groups 1210 are transmitted, respectively.

The power control groups that are not transmitted are simply gated off at the transmitter in order to reduce the overall noise level of the system. The time of transmission of the power control groups is determined by the long spreading code and can be determined once the timing of the system is acquired and once the long code offset of the mobile of interest is known. The substantial gain produced by the integration over one frame, even when the system operates at ⅛ rate and transmits only 2 power control groups, should produce a significant extension of the range of operation of an interceptor over the range of operation of the base station. Simulation results suggest that integration over the two power control groups from a frame transmitted at ⅛ rate could provide useful results even with a signal undergoing Ricean fading with a low power specular component.

It is well known that when an IS-95 CDMA system is operating at rate 1, ½, ¼ or ⅛, either 16, 8, 4 or 2 power control groups are transmitted, resulting in the integration of 24576, 12288, 6144 and 3072 spreading chips, respectively. The resulting gain is 43.9 dB, 40.9 dB, 37.9 dB and 34.9 dB respectively.

In order to maximize the capacity of the reverse link, an IS-95 CDMA mobile adjusts its transmission rate for each frame according to the quantity of information to be transmitted. Therefore the transmission of a mobile is comprised of a few selected power control groups whose time of transmission depends on the long code offset used by the mobile and on the quantity of data that it is transmitting. This makes the measurement of the noise level a difficult matter, since sometimes the signal of the mobile of interest is present and sometimes it is not present. The noise level, once measured, is used to establish an adaptive detection threshold for the desired signal.

With reference, once again, to FIG. 11, the method employed herein to measure the noise level consists of the same signal processing operations 1106, 1110, and 1114 previously used to produce the high gain detectable signal 1118, but in this case the despreading 1120 occurring before these other steps, 1106, 1110, and 1114, is performed using a stored reference signal (not shown) that uses an incorrect offset of the long code, i.e. whose offset is not the offset of the long code used by the mobile of interest, although the timing of the first-to-arrive signal of the mobile of interest is still used. This procedure ensures that the noise has been integrated only over the power control groups transmitted by the mobile. The output signal 1122 from the cumulative procedure of steps 1120, 1106, 1110 and 1114 serves as a minimum signal threshold. That minimum signal threshold signal.1122 is then processed by a threshold setting process 1124 that takes into account desired probabilities of detection and false alarms in order to determine the actual threshold 1126 that is then employed in an adaptive signal threshold detection process 1118 applied to the high gain detectable signal 1116 derived using a stored reference signal (not shown) that uses the same offset of the long code used by the mobile of interest in order to remove the noise present in that signal and extract the final output signal with sufficient gain 1128 corresponding to the signal transmitted by the mobile.

A peculiarity of IS-95 is that the mobile does not inform the base station of the rate at which each frame is transmitted. Consequently, the base station has to process the signal for the four possible rates and then selects the rate producing the best results. The interceptor should do the same and perform the processing for the four possible rates, both for the production of the correlation peak and for the integration of the noise for the setting of the adaptive threshold. The rate giving the best results for the production of the correlation peak should also be used for the setting of the adaptive threshold.

Although some of the embodiments and variations described herein were applied to the IS-95 CDMA cellular system, the invention described herein can be applied to any CDMA system.

It is to be understood that the embodiments and variations shown and described herein are merely illustrations of the principles of this invention and that various modifications may be implemented by those skilled in the art without departing from the spirit and scope of the invention.

What is claimed is:

1. A method for an outdoor geolocation of a mobile of interest in a CDMA cellular system comprising:
(i) dynamically and wirelessly receiving a signal from a mobile whose location is unknown at two or more interceptors, which are located at different known geographic locations inside a CDMA coverage area defined by said base station where a signal from said base station to said mobile is line-of-sight;
(ii) dynamically computing a total time-of-flight of said signal from said base station to each interceptor via said mobile;
(iii) dynamically computing an ellipse of position of said mobile for each total time-of-flight computation, where each ellipse of position has as its foci said base station and said interceptor corresponding to said total time-of-flight measurement for said interceptor;
(iv) dynamically computing intersection point(s) of each possible pair of ellipses of position, if any such intersection point exists;
(v) dynamically and wirelessly receiving said signal from said mobile and measuring an angle-of-arrival of said signal received at each of said interceptors;
(vi) dynamically computing a line of position corresponding to each angle-of-arrival measurements;
(vii) dynamically computing an intersection point of each possible pair of line of position based on angle-of-arrival measurements, if such an intersection point exists;
(viii) dynamically comparing said intersection point(s) of each pair of ellipses of position, if any such intersection point exists with the corresponding intersection point of said lines of position based on angle-of-arrival measurements, if such an intersection point exists; and
(ix) determining either
(a) a geographic area within which the mobile is located that is defined by the area of intersection of all ellipses of position whenever for all possible pair of interceptors, either no intersection point of the angle-of-arrival lines of position corresponding to a pair of interceptors coincides with the intersection point(s) of the ellipses of position corresponding to the same pair of interceptors, or no intersection point of angle-of-arrival lines of position exists, or
(b) the actual position of the mobile whenever the signal from the mobile to each of any pair of interceptors is line-of-sight which occurs whenever the intersection point of the angle-of-arrival lines of position corresponding to the interceptors intersects one of the two intersection points of the ellipses of position corresponding to the interceptors, corresponding to the actual position of the mobile at that time.

2. The method as recited in claim 1, wherein said interceptor measures a network timing of said cellular CDMA system and measures a timing offset used by said base station used to measure the total time-of-flight of a signal.

3. The method as recited in claim 2, wherein said network timing of said CDMA cellular system measured at each interceptor is obtained from a GPS.

4. The method as recited in claim 1, wherein each angle-of-arrival is dynamically computed in two steps, comprising:
(i) the use of phase measurements between separate receiving antennas to perform coarse direction of arrival measurements of the signal received at the interceptor, followed by
(ii) the use of a monopulse measuring technique to perform a high-accuracy geolocation of the mobile when the signal received from the mobile at the interceptor is line-of-sight.

5. The method as recited in claim 4, wherein said separate receiving antennas comprise a Watson-Watt array.

6. The method as recited in claim 5, wherein said separate receiving antennas further comprises an array of three or four antennas, which is used in a presence of an elevation component in the angle-of-arrival of the signal in order to determine the azimuth.

7. The method as recited in claim 4, wherein said monopulse measuring technique is either amplitude comparison or phase comparison in nature.

8. The method as recited in claim 1, wherein said interceptor dynamically applies an adaptive high-gain signal processing to received signal from said mobile.

9. The method as recited in claim 8, wherein the adaptive high-gain signal processing comprises:
(i)(a) despreading said received signal by stripping of a long code and short codes of said signal using a stored reference signal having said long code offset mask that is used by said mobile;
(i)(b) integrating a plurality of spreading chips contained in each Walsh chip;
(i)(c) squaring said Walsh chips;
(i)(d) integrating one frame of Walsh chips over its transmitted power control groups resulting in a high gain detectable signal;
(ii)(a) despreading said received signal by stripping of a long code and short codes of said signal using a stored reference signal having a long code offset mask that is not the offset mask used by said mobile;
(ii)(b) integrating a plurality of spreading chips contained in each Walsh chip described in said step (ii)(a);
(ii)(c) squaring said Walsh chips described in said step (ii)(b);
(ii)(d) integrating one frame of said Walsh chips described in said step (ii)(c) over its transmitted power control groups resulting in a minimum signal threshold;
(ii)(e) determining an actual signal threshold by applying said minimum signal threshold described in said step (ii)(d) to a threshold setting process that takes into account desired probabilities of detection and false alarms; and
(iii) applying an adaptive threshold determination process to said high gain detectable signal from said step (i)(d) using the actual threshold signal from said step (ii)(e) in order to extract an output signal with a higher gain corresponding to said signal received by said interceptor.

10. The method as recited in claim 1 wherein the CDMA cellular system is an IS-95 cellular system.

11. A system for the outdoor geolocation of a mobile of interest in a CDMA cellular system comprising of a plurality of interceptors located at known location inside a CDMA coverage area of a base station, wherein each of said interceptors comprising of:
(i) a means for dynamically obtaining a total-time-of-flight measurement, which is a total propagation time of a signal from said base station to said mobile and from said mobile to said interceptor;
(ii) a means for dynamically obtaining an angle-of-arrival measurement of a signal from said mobile;
(iii) a means for dynamically distinguishing whether said signal received from said mobile is line-of-sight or reflected; and
(iv) a means for dynamically determining a location of said mobile.

12. The system as recited in claim 11, wherein said total time-of-flight measurement is comprising of:
(i) a means for acquiring reverse link channel or traffic channel;
(ii) a means for obtaining a time-of-arrival measurement of a signal from said mobile;
(iii) a means for obtaining a network timing of said CDMA cellular system;
(iv) a means for determining a time of transmission of a signal from said base station; and
(v) a means for determining total time-of-flight based on said time of transmission of said signal from said base station and said time-of-arrival.

13. The system as recited in claim 12, wherein said means for acquiring reverse link channel or traffic channel is comprising of:
(i) a means for acquiring a base station pilot channel consisting of one or more short codes with a network timing offset associated with said base station or its particular sector;
(ii) a means for obtaining forward link synch channel after achieving time synchronization of said base station pilot channel, wherein forward link synch channel consisting of time offset I and Q short code with a Walsh 31 code overlay carrying convolutionally encoded and interleaved; and
(iii) a means for acquiring forward paging channels, wherein said forward paging channels carry channel assignment data and other system overhead information, and is used to build said mobile's long code offset mask.

14. The system as recited in claim 12, wherein said time-of-arrival measurement of a first-to-arrive signal from said mobile is obtained based on the knowledge of said mobile's long code mask.

15. The system as recited in claim 12, wherein said network timing is obtained from a GPS.

16. The system as recited in claim 12, wherein said time of transmission of a signal from said base station is determined based on a knowledge of an offset used by said base station in said transmission of I and Q short code.

17. The system as recited in claim 11, wherein said means for obtaining an angle-of-arrival measurement of a signal from said mobile is antenna main beam or null pointing direction.

18. The system as recited in claim 11, wherein said means for obtaining an angle-of-arrival measurement of a signal from said mobile is Doppler measurement from a revolving antenna or from a ring of commutating antennas.

19. The system as recited in claim 11, wherein said means for obtaining an angle-of-arrival measurement of a signal from said mobile is phase measurement between separate receiving antennas.

20. The system as recited in claim 19, wherein said separate receiving antenna comprises a Watson-Watt antenna array.

21. The system as recited in claim 20, wherein said separate receiving antenna further comprises an array of three or four antennas, which is used in a presence of an elevation component in an angle-of-arrival measurement of a signal.

22. The system as recited in claim 17, wherein said means for obtaining an angle-of-arrival measurement of a signal from said mobile further comprises monopulse measurement based on either phase or amplitude comparison.

23. The system as recited in claim 18, wherein said means for obtaining an angle-of-arrival measurement of a signal from said mobile further comprises monopulse measurement based on either phase or amplitude comparison.

24. The system as recited in claim 19, wherein said means for obtaining an angle-of-arrival measurement of a signal from said mobile further comprises monopulse measurement based on either phase or amplitude comparison.

25. The system as recited in claim 20, wherein said means for obtaining an angle-of-arrival measurement of a signal from said mobile further comprises monopulse measurement based on either phase or amplitude comparison.

26. The system as recited in claim 13 is further comprising an adaptive high-gain signal processing.

27. The system as recited in claim 26, wherein said adaptive high-gain signal processing comprising of:
(i) a means for applying high gain to a received signal;
(ii) a means for measuring noise level to setup an adaptive noise threshold; and
(iii) a means for removing noise present in said signal through an adaptive signal threshold detection process, wherein said adaptive signal threshold detection process utilizes said adaptive noise threshold.

28. The system as recited in claim 27, wherein said means for applying high gain to said signal is comprising of:
(i) a means for despreading said signal using a stored reference signal having a correct long code offset mask for said mobile;
(ii) a means for integrating four spreading chips included in each Walsh chip on a despreaded signal from section (i);
(iii) a means for determining a location of a boundaries of said Walsh chips based on a knowledge of network timing; and
(iv) a means for squaring of Walsh chips, which yields a signal to noise ratio that is twice the signal ratio of said signal before processed.

29. The system as recited in claim 27, wherein said means for measuring noise level to setup an adaptive noise threshold is comprising of:
(i) a means for despreading said signal using a stored reference signal having an incorrect long code offset mask for said mobile;
(ii) a means for integrating four spreading chips included in each Walsh chip on a despreaded signal from section (i);
(iii) a means for determining a location of boundaries of said Walsh chips based on a knowledge of network timing;
(iv) a means for squaring of Walsh chips, which yields a signal to noise ratio that is twice the signal ratio of said signal before processed;
(v) a means for integrating over transmitted power control groups of one frame to determine a minimum signal threshold; and
(vi) a means for determining actual threshold based on said minimum signal threshold by taking desired probabilities of detection and false alarms into account.

30. The system as recited in claim 11, wherein said means for determining a location of said mobile is comprising of:
(i) a means for dynamically calculating a principal ellipse of position of said mobile for each total time-of-flight measurement obtained at each of said interceptor, wherein said ellipse of position has its foci at said base station and said interceptor corresponding to said total time-of-flight measurement;
(ii) a means for dynamically calculating an intersection point(s) of each possible pair of ellipses of position;
(iii) a means for dynamically calculating a line of position based on each of angle-of-arrival measurement obtained by said interceptor;
(iv) a means for dynamically calculating an intersection point of each possible pair of lines of position based on angle-of-arrival of said signal;
(v) a means for classifying whether a first-to-arrive signal at interceptor is line-of-sight or reflected by comparing said intersection of said pair of said principal ellipses of positions with said intersection of said lines of positions of angle-of-arrival measurements;
(vi) a means for determining either a point or a geographic area of estimated location of said mobile.

31. The system as recited in claim 30, wherein said point of estimated location of said mobile is determined whenever first-to-arrive signal from said mobile to each of any pair of said interceptors is line-of-sight, which occurs whenever the intersection point of lines of position of angle-of-arrival corresponding to said interceptors intersects with one of two intersection points of said principal ellipses of position corresponding to said pair of said interceptors.

32. The system as recited in claim 30, wherein said geographic area of estimated location of mobile is determined by an area of intersection of all said principal ellipses of positions for corresponding interceptors when either there is no intersection point of said lines of position of angle-of-arrival for said corresponding pair of interceptors coincides with any of intersection points of said principal ellipses of position, or there is no intersection point of any pair of lines of position of angle-of-arrival for said corresponding pair of interceptors.

33. The system as recited in claim 11, wherein said CDMA cellular system is an IS-95 cellular system.
